(19) United States
(12) Patent Application Publication
(10) Pub. No.: US 2021/0041970 A1
(43) Pub. Date: Feb. 11, 2021

(54) IMPROVED TOUCH-SENSING APPARATUS

(71) Applicant: FlatFrog Laboratories AB, Lund (SE)

(72) Inventors: Håkan Bergström, Torna-Hällestad (SE); Tomas SVENSSON, Limhamn (SE); Thomas Craven-Bartle, Sodra Sandby (SE)

(21) Appl. No.: 16/977,700

(22) PCT Filed: Mar. 5, 2019
(86) PCT No.: PCT/SE2019/050190

§ 371 Date: Sep. 2, 2020

Related U.S. Application Data
(60) Provisional application No. 62/776,361, filed on Dec. 6, 2018.

(30) Foreign Application Priority Data
Mar. 5, 2018 (SE) 1830076-4

(51) Int. Cl. G06F 3/042

(52) U.S. Cl. CPC G06F 3/042

(57) ABSTRACT

A touch sensing apparatus is disclosed, comprising a panel that defines a touch surface extending in a plane having a normal axis, a plurality of emitters and detectors arranged along a perimeter of the panel, a light directing element arranged adjacent the perimeter and comprising a light directing surface, wherein the emitters are arranged to emit light and the light directing surface is arranged to receive the light and direct the light across the touch surface, and wherein an optical axis of the emitted light is at an angle greater than zero from the normal axis of the touch surface.

### TECHNICAL FIELD

The present invention pertains to touch-sensing apparatus that operate by propagating light above a panel. More specifically, it pertains to optical and mechanical solutions for controlling and tailoring the light paths above the panel via fully or partially randomized refraction, reflection or scattering.

### BACKGROUND ART

In one category of touch-sensitive panels known as ‘above surface optical touch systems’, a set of optical emitters are arranged around the periphery of a touch surface to emit light that is reflected to travel and propagate above the touch surface. A set of light detectors are also arranged around the periphery of the touch surface to receive light from the set of emitters from above the touch surface. I.e. a grid of intersecting light paths are created above the touch surface, also referred to as scanlines. An object that touches the touch surface will attenuate the light on one or more scanlines of the light and cause a change in the light received by one or more of the detectors. The location (coordinates), shape or area of the object may be determined by analyzing the received light at the detectors.

Previous above surface touch technology has problems with detectability, accuracy, jitter and object size classification, related to suboptimal scanline width, component count and touch decoding. The width of the scanlines affects touch performance factors such as detectability, accuracy, resolution, the presence of reconstruction artefacts. Problems with previous prior art touch detection systems relate to sub-optimal performance with respect to the aforementioned factors. Some prior art systems aim to improve the accuracy in detecting small objects. This in turn may require incorporating more complex and expensive opto-mechanical modifications to the touch system, such as increasing the number of emitters and detectors, to try to compensate for such losses. This results in a more expensive and less compact system. Furthermore, to reduce system cost, it may be desirable to minimize the number of electro-optical components.

### SUMMARY

An objective is to at least partly overcome one or more of the above identified limitations of the prior art.

One objective is to provide a touch-sensitive apparatus based on “above-surface” light propagation which is robust and compact, while allowing for improved resolution and detection accuracy of small objects.

Another objective is to provide an “above-surface”-based touch-sensitive apparatus with efficient use of light.

One or more of these objectives, and other objectives that may appear from the description below, are at least partly achieved by means of touch-sensitive apparatuses according to the independent claims, embodiments thereof being defined by the dependent claims.

According to a first aspect, a touch sensing apparatus is provided comprising a panel that defines a touch surface extending in a plane having a normal axis, a plurality of emitters and detectors arranged along a perimeter of the panel, a light directing element arranged adjacent the perimeter and comprising a light directing surface, wherein the emitters are arranged to emit light and the light directing surface is arranged to receive the light and direct the light across the touch surface, and wherein an optical axis of the emitted light is at an angle greater than zero from the normal axis of the touch surface.

Some examples of the disclosure provide for a touch sensing apparatus that has a better signal-to-noise ratio of the detected light.

Some examples of the disclosure provide for a touch-sensing apparatus with improved resolution and detection accuracy of small objects.

Some examples of the disclosure provide for a touch-sensing apparatus with a more uniform coverage of scanlines across the touch surface.

Some examples of the disclosure provide for reducing stray light effects.

Some examples of the disclosure provide for reducing ambient light sensitivity.

Some examples of the disclosure provide for a touch-sensing apparatus with less detection artifacts.

Some examples of the disclosure provide for a more compact touch sensing apparatus.

Some examples of the disclosure provide for a touch sensing apparatus that is less costly to manufacture.

Some examples of the disclosure provide for a touch sensing apparatus that is more reliable to use.

Some examples of the disclosure provide for a more robust touch sensing apparatus.

Still other objectives, features, aspects and advantages of the present disclosure will appear from the following detailed description, from the attached claims as well as from the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

These and other aspects, features and advantages of which examples of the invention are capable of will be apparent and elucidated from the following description of examples of the present invention, reference being made to the accompanying drawings, in which;

FIG. 1 is a schematic illustration, in a cross-sectional side view, of a touch-sensing apparatus, according to one example of the disclosure;

FIG. 2 is a schematic illustration, in a cross-sectional side view, of a touch-sensing apparatus, according to one example of the disclosure;

FIG. 3 is a schematic illustration, in a cross-sectional side view, of a touch-sensing apparatus, according to one example of the disclosure;

FIG. 4 is a schematic illustration, in a cross-sectional side view, of a touch-sensing apparatus, according to one example of the disclosure;

FIGS. 5a-b are schematic illustrations, in cross-sectional side views, of a touch-sensing apparatus, according to examples of the disclosure;

FIG. 6 is a schematic illustration, in a cross-sectional side view, of a touch-sensing apparatus, according to one example of the disclosure;

FIG. 7 is a diagram showing an example of the total reflectance (%), i.e. diffusive and specular reflection, for black anodized aluminium as function of the wavelength (nm);

FIG. 8 is a schematic illustration, in a cross-sectional side view, of a touch-sensing apparatus, according to one example of the disclosure; and

FIG. 9 is a schematic illustration, in a cross-sectional side view, of a touch-sensing apparatus, according to one example of the disclosure.

### DETAILED DESCRIPTION OF EXAMPLE EMBODIMENTS

In the following, embodiments of the present invention will be presented for a specific example of a touch-sensitive apparatus. Throughout the description, the same reference numerals are used to identify corresponding elements.

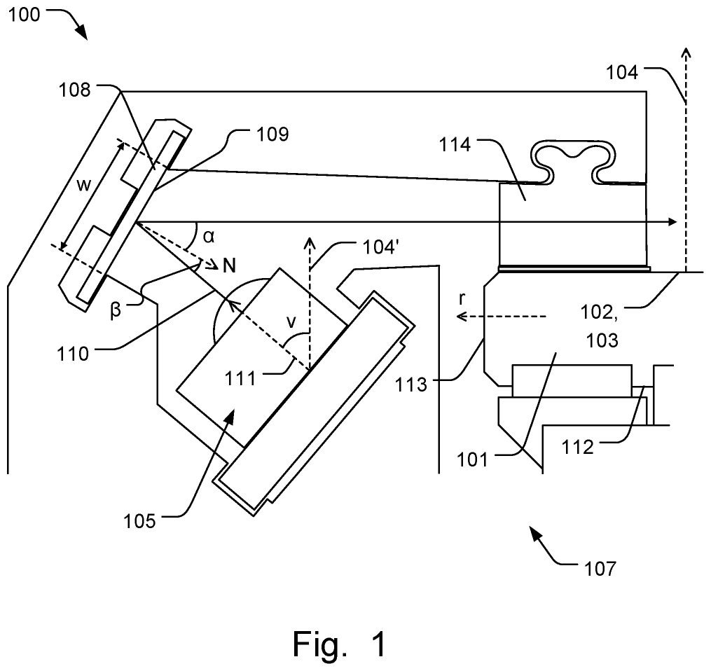

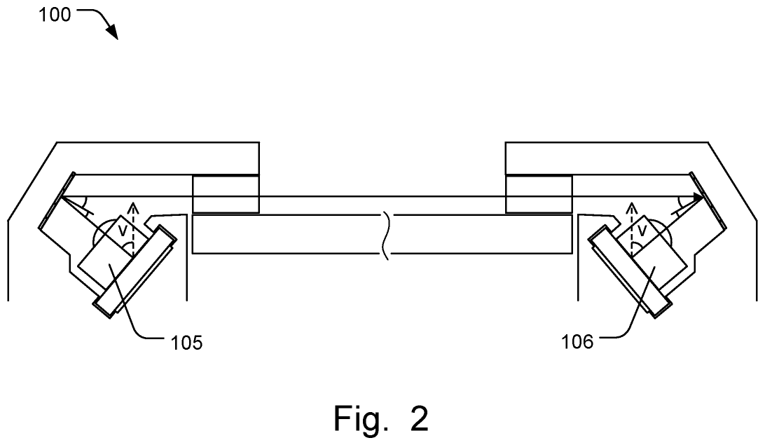

FIG. 1 is a schematic illustration of a touch-sensing apparatus 100 comprising a panel 101 that defines a touch surface 102 extending in a plane 103 having a normal axis 104. The panel 101 is a light transmissive panel in one example. The touch-sensing apparatus 100 comprises a plurality of emitters 105 and detectors 106 arranged along a perimeter 107 of the panel 101. FIG. 1 shows only an emitter 105 for clarity of presentation, while FIG. 2 illustrates how light is transmitted from an emitter 105 to a detector 106 across the touch surface 102. The touch-sensing apparatus 100 comprises a light directing element 108 arranged adjacent and along the perimeter 107. The light directing element 108 comprises a light directing surface 109. The emitters 105 are arranged to emit light 110 and the light directing surface 109 is arranged to receive the light 110 and direct the light across touch surface 102 of the panel 101. The emitter 105 is angled so that an optical axis 111 of the light 110 emitted by the emitter 105 is at an angle (v) greater than zero from the normal axis 104 of the touch surface 102, as schematically shown in the example of FIG. 1. The axis indicted 104′ is parallel with the normal axis 104. The detectors 106 may be arranged at a corresponding angle (ν) as schematically shown in FIG. 2. Having the optical axis 111 arranged at an angle (ν) greater than zero from the normal axis 104 provides for a more even illumination of the width (w) of the light directing element 108 and a stronger carrier signal for the touch detection process. An angle α relative a normal (N) of the light directing surface 109 and the plane 103 of the touch surface 102, as well as an angle β relative said normal axis (N) and the optical axis 111 is also indicated in FIG. 1. Having the angle ν>0, gives α+62 <90 degrees, since α+β=90−ν. This provides for maximizing the intensity (I) of the light directed across the touch surface 102, since said intensity (I) is proportional to cos (α) multiplied by cos (β), i.e.; I ∝ cos (α)*cos (β). Thus, providing for decreasing α and/or β, as ν increases, provides for larger cosine factors; cos (α) and/or cos (β), and thereby an increase in the intensity (I). The accuracy of the touch detection process may be increased since the amount of light available for the touch detection increases. The amount of noise can be reduced and the strength of the carrier signal for the touch detection may be increased. These advantageous benefits are provided for a range of angles α of the light directing surface 109 relative the plane 103, and for a range of angles β of the light directing surface 109 relative optical axis 111 as described in more detail below with respect to FIGS. 1-6, 8 and 9.

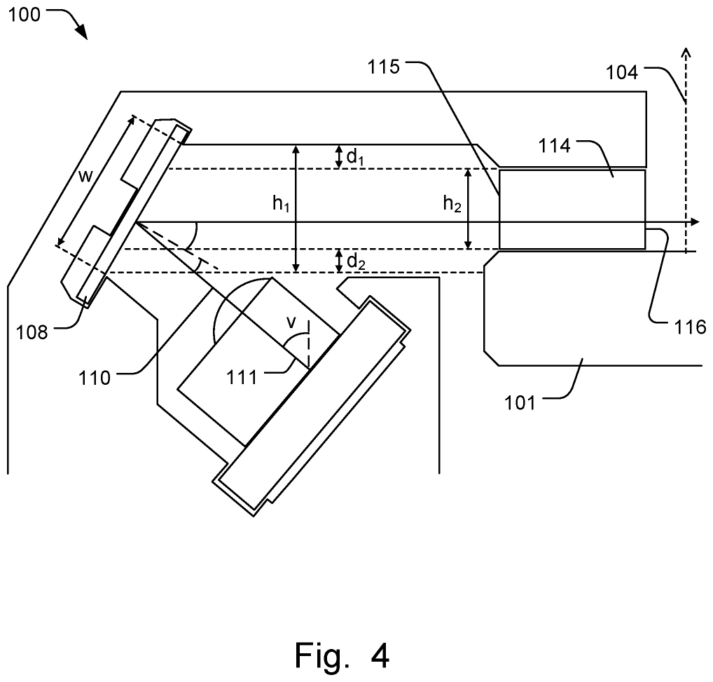

In one example, α=45 degrees, and β<45 degrees since ν>0. This provides for an increase in the intensity (I) from a default factor of I=0.5, which would otherwise be the case if ν=0 and thereby α=β=45 degrees. The intensity (I) is >0.5 for all angles β<45 degrees. This also holds for examples where α<45 degrees, as shown e.g. in FIG. 1. I.e. an angle (α) between a normal axis (N) of the light directing surface 109 and the plane 103 of the touch surface 102 may be less than 45 degrees. It is also conceivable that β>45 degrees in the case α<45 degrees. The angle α may in such case be decreased further to off-set the impact on the intensity (I) when having β>45 degrees, given I ∝ cos (α)*cos (β). Reducing α also provides for minimizing the width (w) of the light directing element 108, for a given height h₂ as indicated at the second light directing element 114 in FIG. 4, since w=h₂/cos (α). This provides for a more compact touch sensing apparatus 100.

Hence, having the optical axis 111 arranged at an angle ν>0 provides for increasing the intensity (I), e.g. by minimizing β as exemplified in FIG. 1 where the emitter 105 has been rotated so that the angle ν is approximately 45 degrees relative axis 104′. This also allows for the light directing element 108 to be rotated along with the emitter 105 to minimize α, and optimize the relationship between α and β to further increase the intensity (I). The emitter 105 may be angled so that ν is maximized, thereby minimizing α and β, which may be particularly advantageous when the light 110 is emitted around the sides 113 of the panel 101 as seen in the example of FIG. 1. The configuration of the touch sensing apparatus 100 as illustrated in the example of FIG. 1, with v>0 degrees and α<45 degrees, and having the light directed around the panel sides 113, may thus be particularly advantageous for maximizing the aforementioned intensity (I).

The angle α may be in the range 0-35 degrees. This provides for a particularly advantageous optimization of the intensity (I) of the light directed across the touch surface 102 and a more accurate and robust touch detection. The angle α may be optimized depending on the particular application and configuration of the touch sensing apparatus 100.

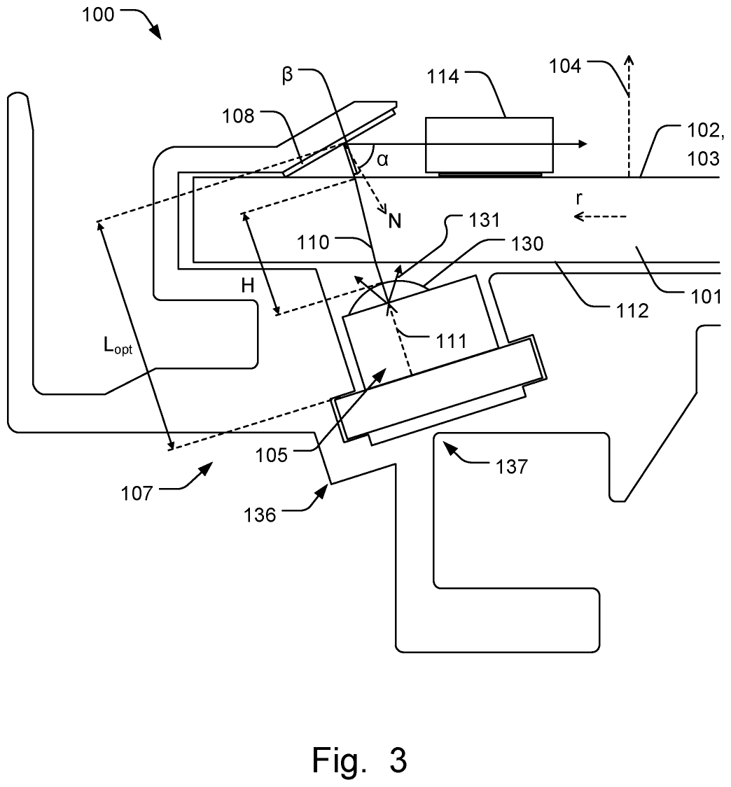

FIG. 3 show another example of the touch sensing apparatus 100, where α>45 degrees. I.e. an angle (α) between the normal axis (N) of the light directing surface 109 and the plane 103 of the touch surface 102 may be more than 45 degrees. In this case, having the optical axis 111 arranged at an angle ν>0 gives β<45 degrees. This is advantageous in some applications where it is desired to have α>45 degrees, i.e. having the light directing element 108 angled more downwards towards the touch surface 102, since the impact on the intensity (I) as a increases may be reduced by having β<45 degrees, given I ∝ cos (α)*cos (β). The optical axis 111 may be angled so that β is minimized to provide such compensating effect on the intensity (I). Having α>45 degrees may provide for a more compact touch sensing apparatus 100, both in terms of reducing the height of the light directing element 108 above the touch surface 102, and to facilitate reflection of the light through the panel 101, as seen in the example of FIG. 3. Hence, having the optical axis 111 arranged at an angle ν>0 provides for a compact opto-mechanical configuration of the touch sensing apparatus 100. The angle (α) may be in the range 50-70 degrees. This may provide for a particularly compact touch sensing apparatus 100.

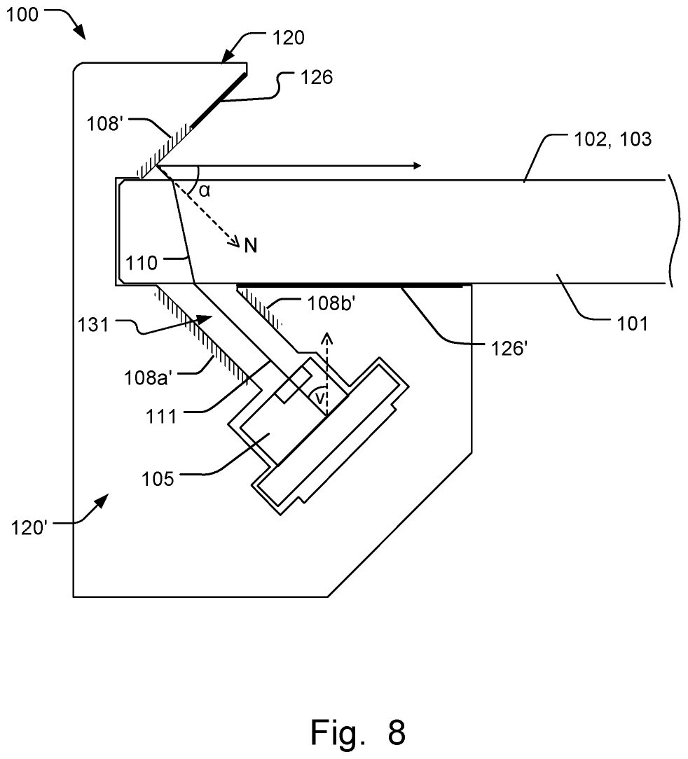

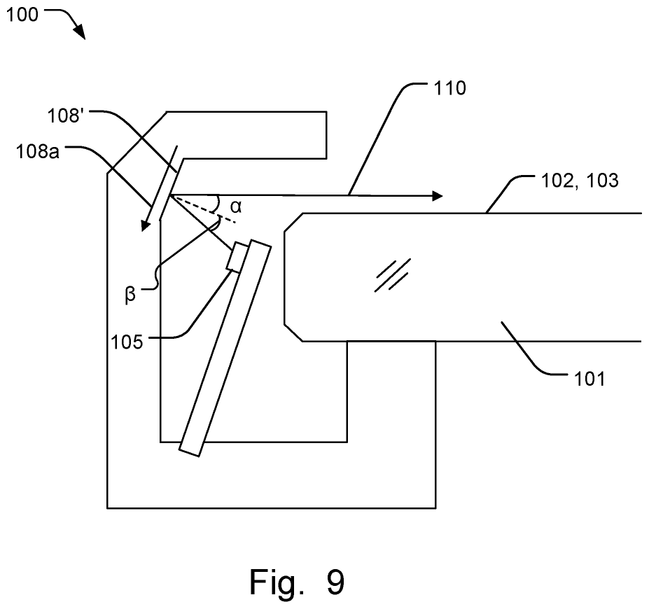

FIGS. 8 and 9 show further schematic examples, described further below, where the emitters 105 (and detectors 106) have been arranged to direct light towards the light directing element 108, preferably at the smallest angle β possible relative to the normal (N) of the light directing element 108. FIG. 8 show an example where β is close to zero. Likewise, the light directing element 108 is arranged direct light across the plane 103 preferably at the smallest angle α possible relative to the plane 103.

It should be understood that ν may assume various values, while providing for the advantageous effects as described, such as ν=10, 20, 30, 40, 50, 60, 70, 80 degrees.

The angle (β) between the normal axis (N) of the light directing surface 109 and the optical axis 111 may be less than 45 degrees, such as seen in e.g. FIGS. 1-4. This provides for facilitating maximizing the intensity (I). It is to be noted that β will be less than 45 degrees when α>45 degrees, as in the example of FIG. 3.

The angle (α) may be equal to the angle (β). This provides for an optimized relationship between α and β when I ∝ cos (α)*cos (β), which gives I ∝ (cos (α))², for maximizing I in this case. This is also particularly advantageous in case specular light reflection between the emitters/detectors 105, 106, and the touch surface 102 is needed. The angle β may be in the range 0-30 degrees. This provides for a particularly advantageous optimization of the intensity (I) of the light directed across the touch surface 102 and a more accurate and robust touch detection. The angle β may be optimized depending on the particular application and configuration of the touch sensing apparatus 100.

The light directing element 108 may comprises a diffusive light scattering element 108, in which case the light directing surface 109 diffusively reflects the light across the touch surface 102. The diffusive light scattering element 108 is arranged in the path of the light 110 between the emitters 105 or detectors 106 and the touch surface 102. I.e. the light emitted from emitters 105 is scattered by the diffusive light scattering element 108 in the light path between the emitters 105 and the touch surface 102. Any of the light directing elements 108 as schematically illustrated in FIGS. 1-6, 8 and 9 may comprises a diffusive light scattering element 108. Having a diffusive light scattering element 108 arranged in the path of the light 110 provides for an optimized coverage of light in the plane 103 of the touch surface 102. The position and characteristics of the diffusive light scattering element 108 in relation to the emitters 105, detectors 106, second light directing element 114 (if any) and the panel 101 may be varied for optimization of the performance of the touch-sensing apparatus 100 to various applications. Further variations are conceivable within the scope of the present disclosure while providing for the advantageous benefits as generally described herein. The described examples refer primarily to aforementioned elements in relation to the emitters 105, to make the presentation clear, although it should be understood that the corresponding arrangements may also apply to the detectors 106. Different variations of the diffusive light scattering element 108 have been described further below.

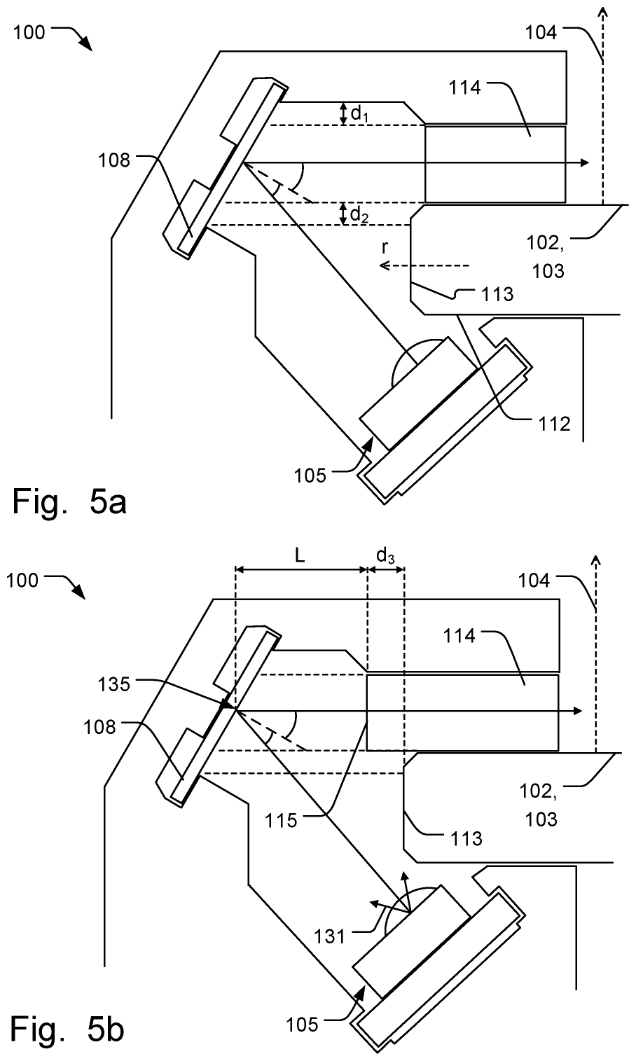

The panel 101 comprises a rear surface 112, opposite the touch surface 102, and panel sides 113 extending between the touch surface 102 and the rear surface 112. The light directing element 108 may be arranged outside the panel sides 113, along a direction (r) perpendicular to the normal axis 104 of the touch surface 102, to receive light from the emitters 105, or to direct light to the detectors 106, around the panel sides 113. Directing the light around the panel 101 provides for minimizing reflection losses and maximizing the amount of light available for the touch detection process. Such arrangement also facilitates maximizing the angle ν, and minimizing α and β, since there is no transmission of light through the panel 101 along the optical axis 111. FIGS. 4, 5a-b, 6, and 9 show further examples of having the emitters 105, and detectors 106, and the light directing element 108 arranged to direct light around the panel sides 113.

The emitters 105 and/or the detectors 106 may be arranged at least partly opposite the panel sides 113, as schematically shown in e.g. FIG. 1. This provides for reducing the thickness of the touch sensing apparatus 100 along the direction of the normal 104. A more compact touch sensing apparatus 100 may thus be provided. Further, the distance between the emitter 105 and the light directing element 108 may be reduced, which may provide for increasing the amount of light received at light directing element 108 from the emitter 105 in some applications.

FIGS. 5a-b show another example where the emitters 105 and/or the detectors 106 are be arranged at least partly opposite the rear surface 112 of the panel 101. This provides on the other hand for reducing the dimensions of the touch sensing apparatus 100 in a direction (r) perpendicular to the normal axis 104, which may be desirable in some applications where the amount of space in this direction is limited, and/or when the ratio of available touch surface 102 to the surrounding frame components is to be optimized. Having the emitters 105 and/or the detectors 106 arranged at least partly opposite the rear surface 112 also provides for extending the length of the light path, between the emitters 105 and the light directing element 108. This may in some applications provide for illuminating the directing element 108 with a wider emission cone of emitted light from the emitter 105. This may in turn provide for increasing the width of the scanlines across the touch surface 102, and further increasing the ability to detect even smaller objects on the touch surface 102.

The diffusive light scattering element 108 may extend at least partly above the touch surface 102, as schematically illustrated in e.g. FIG. 5a. Having a separation between the emitters 105 and the diffusive light scattering element 108, as allowed by e.g. positioning the latter above the touch surface 102, and arranging the emitters 105 below the touch surface 102 may provide for increasing the effective size of the emitters 105 and detectors 106, i.e. broadening of the scanlines, and also a compact profile of the touch-sensing apparatus around the periphery 107.

The emitters 105 may be arranged to emit light outwards from the panel 101 towards the perimeter 107 thereof for reflection at the light directing element 108, as schematically illustrated in e.g. FIGS. 5a-b. Such arrangement may be advantageous in some applications for providing a further broadening of the scanlines across the touch surface 102, since the length of the light path 110 may be increased. The effective light source position may also be shifted outwards, in case of having a diffusive light scattering at the light directing element 108, hence improving the touch performance at the edges of the touch surface 102.

The light directing element 108 may be arranged to receive light from the emitters 105, or to direct light to the detectors 106, through the panel 101, as schematically shown in the examples of FIGS. 3 and 8. The emitters 105, and detectors 106, are arranged opposite the rear surface 112 of the panel 101. This provides for further reducing the dimensions of the touch sensing apparatus 100 in a direction (r) perpendicular to the normal axis 104, which may be desirable in some applications where the amount of space in this direction further restricted. Having the emitters 105, and detectors 106, arranged at an angle (ν) in this configuration provides for increasing the intensity (I) of the light available at the touch surface 102 for the touch detection, as described above. It may thus possible to compensate for any loss of light, if any, when directing the light through the panel 101.

The light directing element 108 may be a first light directing element 108, and the touch sensing apparatus 100 may comprise a second light directing element 114 arranged adjacent the parameter 107, as schematically shown in FIGS. 1-6. As further shown in e.g. FIG. 4, the second light directing element 114 may be arranged to receive light reflected by the first light directing element 108 through a first surface 115, and to couple out the received light through a second surface 116, to direct the light across the touch surface 102 substantially parallel to the touch surface 102. The second light directing element 114 may provide sealing of the light directing element 108, and the emitters 105/detectors 106, from the outside environment.

The first light directing element 108 may receive light from the emitter 105, or reflect light to the detectors 106, along a width (w), as further shown in FIG. 4. A projected height (h₁) of the width (w) along the normal axis 104 may be longer than a height (h₂) of the first surface 115 along the normal axis 104. I.e. the first light directing element 108 extends a distance (d₁, d₂) beyond the first surface 115, as indicated in e.g. FIG. 4 and FIG. 5a. Such ‘oversized’ light directing element 108, relative the second light directing element 114, provides for compensating any imperfections in the first and/or second surfaces 115, 106, which may produce light reflections over a wider width at the light directing element 108. Hence, increasing the width (w) of the first light directing element 108 and the height (h₂) allows for utilizing this light and minimize any reflection losses.

The second light directing element 114 may be positioned against the panel 101 and extend with an off-set distance (d₃) beyond a side 113 of the panel 101 towards the first light directing element 108 in the direction of the plane 103, as schematically illustrated in FIG. 5b. This provides for minimizing the distance (L) between the second light directing element 114 and the first light directing element 108, and utilizing more of the light reflected by the light directing element 108.

In one example, the distance (L) from intersection point 135 at the first light directing element 108 to the first surface 115 is less than 4 mm. Preferably, the second light directing element 114 does not block the emission cone 131.

In one example, the first surface 115 and/or the second surface 116 of the second light directing element 114 are/is not concave. In one example, the first surface 115 and/or the second surface 116 of the second light directing element 114 do not have unequal angles from the normal 104 of the touch surface 102. In another example, the first surface 115 and/or the second surface 116 of the second light directing element 114 are substantially parallel with the normal 104 of the touch surface 102. In one example, the first surface 115 and/or the second surface 116 of the second light directing element 114 are/is not convex. The second light directing element 114 may comprise a lens providing a lens effect. The first light directing element 108, such as a diffusive light scattering element 108 may be within the focal length of such lens. Configurations for positioning of lower support 136 and wall thickness 137 as exemplified in FIG. 3 may be varied.

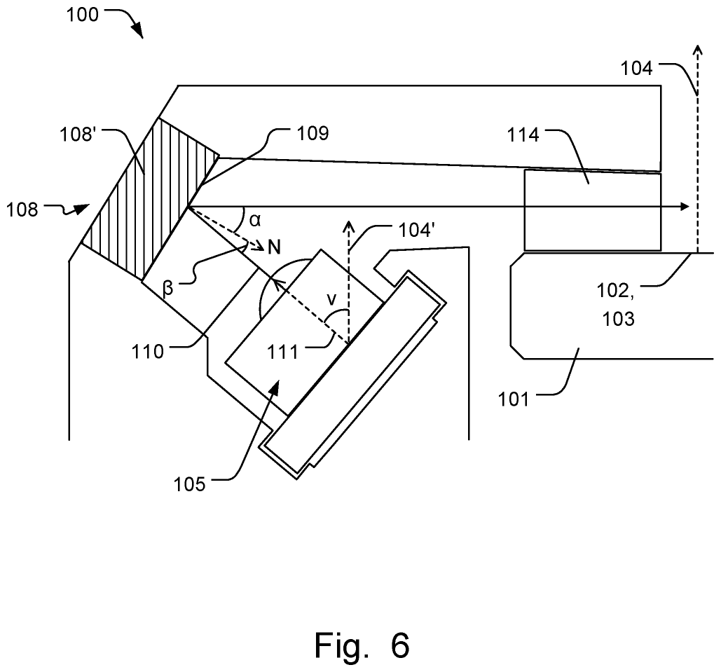

The aforementioned light directing element may comprise a frame element 108, 108′ of the touch sensing apparatus 101, and the frame element 108′ may be formed of black anodized metal to diffusively reflect the light towards the touch surface 102. The light directing surface 109 of the frame element 108′ is thus diffusively reflective. FIG. 6 shows a schematic example where the light directing element 108 comprises such frame element 108′, formed of black anodized metal. The frame element 108′ may thus acts as a diffusive light scattering element, without having to provide a separate diffusive light scattering element. FIGS. 8 and 9 show further examples where the light directing element 108 comprises a frame element 108′ of the touch sensing apparatus 101, and where the frame element 108′ comprises anodized metal to diffusively reflect the light towards the touch surface 102.

In one example, a lens 130 may be arranged on the emitters 105, as schematically illustrated in e.g. FIG. 3. The lens 130 may be chosen to obtain a desired emission cone 131 of the light along axis 111 from emitter 105. The resulting scanline is dependent on the emission cone 131 of the light along axis 111 from emitter 105. The angle of the light distribution between the two illustrated arrows 131 for the emission cone in FIG. 3 may be denoted θ. The angle of the light distribution in depth axis of FIG. 3 (i.e. orthogonal to normal 104 and outward direction (r)) may be denoted ϕ. An example of a desired emission cone 131 may be an emission cone 131 having θ_{FWHM}=25° and ϕ_{FWHM}=75°, where θ_{FWHM} defines the angle of light distribution in the vertical plane and ϕ_{FWHM} defines the angle of light distribution in the horizontal plane. A lens configuration to achieve this desired emission cone may be an asymmetrical lens configuration. Preferably, lens configuration values are chosen to maintain a compact and efficient design.

As mentioned previously, angle β may be minimized to increase the portion of the light from emitter 105 that is successfully diffused and used as part of a scanline. Angle α may be minimized, while keeping the subtended θ-angle as close to θ_{FWHM} as possible. i.e.

$$Tan {θ}_{FWHM} \approx \frac{\frac{H}{Cos ( α )}}{2 {L}_{opt}}$$

where Lₒₚₜ and H is indicated in FIG. 3. H is the distance from the lens 130 to the touch surface 102 of the touch panel 101.

As mentioned, the light directing element 108 may comprise a diffusive light scattering element 108. Further examples of diffusive light scattering elements 108 will now be described.

Turning to FIG. 9, the diffusive light scattering element 108′ may be formed from a grooved surface, wherein the grooves generally run generally vertically, i.e. in the plane of the schematic cross section of e.g. FIG. 9 and in the direction shown by arrow 108a, which is perpendicular to the normal of the surface of diffusive light scattering element 108′. In other words, the grooves are orientated from a top edge to a bottom edge of the reflector surface such that the scattered light is primarily directed to the touch plane 103. Most preferably, the grooves occur in one direction. Generally speaking, the angle between the vertical (when the touch surface is horizontal) and the grooves should be minimized to optimize signal and scanline broadening. In this embodiment, the angle β between the normal of the grooved surface and light ray coming from the emitter component 105 is same as angle α between normal of grooved surface and the plane of the light rays 110 travelling to the touch surface 102. The angle of the normal of the grooved surface bisects the angle of the light ray travelling to the grooved surface and the light ray travelling to the touch surface 102. Optionally, the arrangement of the grooves on the grooved surface is substantially randomized. The groove density is preferably greater than 10 per mm in a horizontal plane. Optionally, the groove depth is up to 10 microns. Preferably, the average groove width is less than 2 microns. The grooves forming the diffusive light scattering element 108′ can be formed by scratching or brushing of the surface.

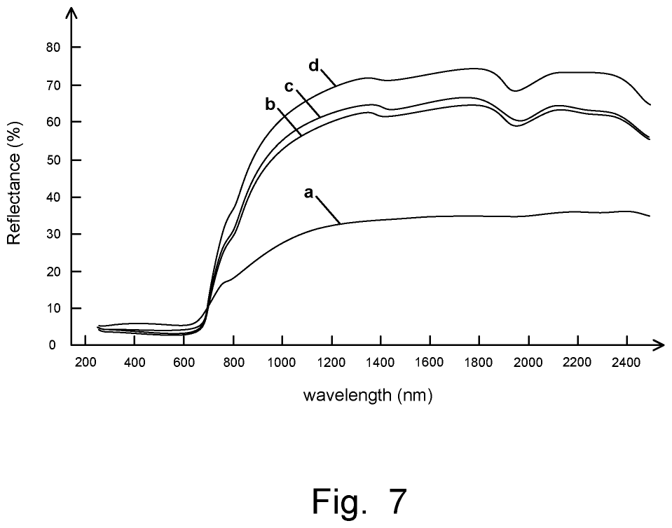

As mentioned above, the diffusive light scattering element 108 may be formed from a surface of a frame element 108′ directly. Frame element 108′ may be an extruded profile component or, alternatively, frame element 108′ is made from brushed sheet metal. Preferably, frame element 108′ is formed from anodized metal, such as anodized aluminum. Grooves for diffusively reflecting the light may be formed from scratching or brushing the anodized layer of the aluminum. In one embodiment, the anodization is a reflective type. In one example, the anodized metal, e.g. anodized aluminium, is cosmetically black in the visible spectral range, but diffusively light scattering in the near infrared range, e.g. wavelengths above 800 nm. FIG. 7 shows an example of the total reflectance (%), i.e. diffusive and specular reflection, for black anodized aluminium as function of the wavelength (nm). The curves (denoted a-c) represent anodized aluminium material having undergone different treatments which affect the reflective characteristics. E.g. curve (c) represents raw anodized aluminium, while (b) is the machined anodized aluminium; (d) is polished anodized aluminium; and (a) is bead-blasted anodized aluminium, respectively. As seen in FIG. 7, the total reflectance increases with the wavelength in the range starting around 700 nm until about 1300 nm. It may be particularly advantageous to use wavelengths above 940 nm where many anodized materials start to reflect significantly (e.g. around 50%).

FIG. 8 shows another schematic example of a touch sensing apparatus 100, described further below, where a frame element, overall denoted with references 120, 120′, may comprise black anodized aluminium where diffusive light scattering portions 108a′, 108b′ are provided along the path of the light 110. The anodized surfaces may not only be used as a diffusive light scattering element but may also be utilized as a reflective element that allows better light management, e.g. recycling of light and reflecting light from lost directions towards the diffusive light scattering portion 108′. The path of the light 110, emitted along angled optical axis 111, is directed through the panel 101, hitting an angled diffusive light scattering surface or element 108′, which may be an anodized metal surface, e.g. anodized aluminium, as exemplified above. Further diffusive light scattering surfaces 108a′, 108b′, may be provided on the opposite side of the panel 101 along a cavity 131 through which the light travels between the emitter 103 (or detector 104) and the backside of the panel 101. Having a plurality of reflections at diffusive light scattering elements 108′, 108a′, 108b′ provides for utilizing a larger portion of the emitted light 110. Any plurality of such elements, i.e. diffusively reflective surfaces 108′, 108a′, 108b′, as part of an anodized frame element 120, 120′, or separate diffusive light scattering elements, may be provided in the light path 110.

The anodized extruded aluminium part of the frame element 120, 120′, may be cosmetically black, but diffusively reflective in the infrared wavelengths. It is conceivable that other anodized metals and alloys may provide for an advantageous diffusive scattering of the light along the light path 110. This provides for a compact touch sensing apparatus 100 since separate diffusive light scattering elements may be dispensed with, and the number of components may be reduced. Angles α and β may be optimized as described above for maximizing the intensity (I) of the light across the touch surface 102.

A light absorbing surface 126 may be provided at the frame element 120 comprising the angled diffusive light scattering surface 108, arranged above the touch surface 102, as schematically illustrated in FIG. 8. The light absorbing surface 126 provides for reducing unwanted reflections from ambient light. The light absorbing surface 126 may be omitted in some examples, providing for reducing the height of the angled frame element 120 above the panel 101, i.e.

to reduce the bezel height. A second light absorbing surface 126′ may be provided between the panel 101 and the frame element 120′, at the backside of the panel 101, opposite the touch surface 102, as schematically illustrated in FIG. 8 to further reduce unwanted light reflections from ambient light. The touch sensing apparatus 100 in the example of FIG. 8 may be particularly advantageous in some applications where additional compactness is desired, since a second light directing element 114 may be omitted. This provides also for reducing the cost of the touch sensing apparatus 100. The angle by which the light scatters across the panel 101 may be further increased, providing for an improved scanline coverage across the panel 101, as Fresnel reflection losses can be avoided. The panel 101 may act as a sealing portion, similar to the second light directing element 114 referred to above, to protect electronics from e.g. liquids and dust. The panel 101 may be provided with a print to block unwanted ambient light and to provide for a pleasing cosmetic appearance.

Further examples of diffusive light scattering elements 108 will now be described.

A diffusive light scattering element 108 may be arranged at, or in, the surface 109 receiving the emitted light 110 from the emitters 105. It can also be implemented by distributing scattering particles (e.g. TiO₂) in the bulk of at least part of the frame element 120, 120′, including the reflective surface 109.

The diffusive light scattering element 108 may be configured as an essentially ideal diffuse reflector, also known as a Lambertian or near-Lambertian diffuser, which generates equal luminance in all directions in a hemisphere surrounding the diffusive light scattering element. Many inherently diffusing materials form a near-Lambertian diffuser. In an alternative, the diffusive light scattering element 108 may be a so-called engineered diffuser with well-defined light scattering properties. This provides for a controlled light management and tailoring of the light scattering abilities. A film with groove-like or other undulating structures may be dimensioned to optimize light scattering at particular angles. The diffusive light scattering element 108 may comprise a holographic diffuser. In a variant, the engineered diffuser is tailored to promote diffuse reflection into certain directions in the surrounding hemisphere, in particular to angles that provides for the desired propagation of light above and across the touch surface 102.

The diffusive light scattering element may be configured to exhibit at least 50% diffuse reflection, and preferably at least 90% diffuse reflection.

The diffusive light scattering element 108 may be implemented as a coating, layer or film applied by e.g. by anodization, painting, spraying, lamination, gluing, etc. In one example, the scattering element 108 is implemented as matte white paint or ink. In order to achieve a high diffuse reflectivity, it may be preferable for the paint/ink to contain pigments with high refractive index. One such pigment is TiO₂, which has a refractive index n=2.8. The diffusive light scattering element 108 may comprise a material of varying refractive index. It may also be desirable, e.g. to reduce Fresnel losses, for the refractive index of the paint filler and/or the paint vehicle to match the refractive index of the material on which surface it is applied. The properties of the paint may be further improved by use of EVOQUE™ Pre-Composite Polymer Technology provided by the Dow Chemical Company. There are many other coating materials for use as a diffuser that are commercially available, e.g. the fluoropolymer Spectralon, polyurethane enamel, barium-sulphate-based paints or solutions, granular PTFE, microporous polyester, GORE® Diffuse Reflector Product, Makrofol® polycarbonate films provided by the company Bayer AG, etc.

Alternatively, the diffusive light scattering element 108 may be implemented as a flat or sheet-like device, e.g. the above-mentioned engineered diffuser, diffuser film, or white paper which is attached by e.g. an adhesive. According to other alternatives, the diffusive light scattering element 108 may be implemented as a semi-randomized (non-periodic) micro-structure on an external surface 109 possibly in combination with an overlying coating of reflective material.

A micro-structure may be provided on such external surface 109 and/or an internal surface by etching, embossing, molding, abrasive blasting, scratching, brushing etc. The diffusive light scattering element 108 may comprise pockets of air along such internal surface that may be formed during a molding procedure. In another alternative, the diffusive light scattering element 108 may be light transmissive (e.g. a light transmissive diffusing material or a light transmissive engineered diffuser) and covered with a coating of reflective material at an exterior surface. Another example of a diffusive light scattering element 108 is a reflective coating provided on a rough surface.

The diffusive light scattering element 108 may comprise lenticular lenses or diffraction grating structures. Lenticular lens structures may be incorporated into a film. The diffusive light scattering element 108 may comprise various periodical structures, such as sinusoidal corrugations provided onto internal surfaces and/or external surfaces. The period length may be in the range of between 0.1 mm-1 mm. The periodical structure can be aligned to achieve scattering in the desired direction.

Hence, as described, the diffusive light scattering element 108 may comprise; white- or colored paint, white- or colored paper, Spectralon, a light transmissive diffusing material covered by a reflective material, diffusive polymer or metal, an engineered diffuser, a reflective semi-random micro-structure, in-molded air pockets or film of diffusive material, different engineered films including e.g. lenticular lenses, or other micro lens structures or grating structures. The diffusive light scattering element 108 preferably has low NIR absorption.

In a variation of any of the above embodiments wherein the diffusive light scattering element provides a reflector surface, the diffusive light scattering element may be provided with no or insignificant specular component. This may be achieved by using either a matte diffuser film in air, an internal reflective bulk diffusor or a bulk transmissive diffusor. This allows effective scanline broadening by avoiding the narrow, super-imposed specular scanline usually resulting from a diffusor interface having a specular component, and providing only a broad, diffused scanline profile. By removing the super-imposed specular scanline from the touch signal, the system can more easily use the broad, diffused scanline profile. Preferably, the diffusive light scattering element has a specular component of less than 1%, and even more preferably, less than 0.1%. Alternatively, where the specular component is greater than 0.1%, the diffusive light scattering element is preferably configured with surface roughness to reduce glossiness. E.g. micro structured.

The touch sensing apparatus may further comprise a shielding layer (not shown). The shielding layer may define an opaque frame around the perimeter of the panel 102. The shielding layer may increase the efficiency in providing the diffusively reflected light in the desired direction, e.g. by recycling the portion of the light that is diffusively reflected by the diffusive light scattering element 108 in a direction away from the panel 101. Similarly, providing a shielding layer on the second light directing element 114, or frame element 120, 120′, arranged at a detector 106 can further reduce the amount of stray light and ambient light that reaches the detector 106. The shielding layer may have the additional function of blocking entry of ambient light through a second light directing element 114 as illustrated in some examples, or generally along the light path 110 between the diffusive light scattering element 108 and the detector/emitter 105, 106.

The panel 101 may be made of glass, poly(methyl methacrylate) (PMMA) or polycarbonates (PC). The panel 101 may be designed to be overlaid on or integrated into a display device or monitor (not shown). It is conceivable that the panel 101 does not need to be light transmissive, i.e. in case the output of the touch does not need to be presented through panel 101, via the mentioned display device, but instead displayed on another external display or communicated to any other device, processor, memory etc.

As used herein, the emitters 105 may be any type of device capable of emitting radiation in a desired wavelength range, for example a diode laser, a VCSEL (vertical-cavity surface-emitting laser), an LED (light-emitting diode), an incandescent lamp, a halogen lamp, etc. The emitter 105 may also be formed by the end of an optical fiber. The emitters 105 may generate light in any wavelength range. The following examples presume that the light is generated in the infrared (IR), i.e. at wavelengths above about 750 nm. Analogously, the detectors 106 may be any device capable of converting light (in the same wavelength range) into an electrical signal, such as a photo-detector, a CCD device, a CMOS device, etc.

With respect to the discussion above, “diffuse reflection” refers to reflection of light from a surface such that an incident ray is reflected at many angles rather than at just one angle as in “specular reflection”. Thus, a diffusively reflecting element will, when illuminated, emit light by reflection over a large solid angle at each location on the element. The diffuse reflection is also known as “scattering”.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the specific arrangement of emitters and detectors as illustrated and discussed in the foregoing is merely given as an example. The inventive coupling structure is useful in any touch-sensing system that operates by transmitting light, generated by a number of emitters, across a panel and detecting, at a number of detectors, a change in the received light caused by an interaction with the transmitted light at the point of touch.

1.-19. (canceled)

20. A touch sensing apparatus comprising
a panel that defines a touch surface extending in a plane having a normal axis,
a plurality of emitters and detectors arranged along a perimeter of the panel,
a light directing element arranged adjacent the perimeter and comprising a light directing surface,
wherein the emitters are arranged to emit light and the light directing surface is arranged to receive the light and direct the light across the touch surface, and
wherein an optical axis of the emitted light is at an angle greater than zero from the normal axis of the touch surface.

21. A touch sensing apparatus according to claim 20, wherein the light directing element comprises a diffusive light scattering element, and wherein the light directing surface diffusively reflects the light across the touch surface.

22. A touch sensing apparatus according to claim 20, wherein the light directing surface has a normal axis, wherein an angle between the normal axis and the plane of the touch surface is less than 45 degrees.

23. A touch sensing apparatus according to claim 22, wherein the angle is in the range 0-35 degrees.

24. A touch sensing apparatus according to claim 20, wherein the light directing surface has a normal axis, wherein an angle between the normal axis and the plane of the touch surface is more than 45 degrees.

25. A touch sensing apparatus according to claim 24, wherein the angle is in the range 50-70 degrees.

26. A touch sensing apparatus according to claim 20, wherein the light directing surface has a normal axis, wherein an angle between the normal axis and the optical axis is less than 45 degrees.

27. A touch sensing apparatus according to claim 22, wherein the light directing surface has a normal axis, wherein an angle between the normal axis and the optical axis is less than 45 degrees, and wherein the angle is equal to the angle.

28. A touch sensing apparatus according to claim 26, wherein the angle is in the range 0-30 degrees.

29. A touch sensing apparatus according to claim 20, wherein the panel comprises a rear surface, opposite the touch surface, and panel sides extending between the touch surface and the rear surface,
wherein the light directing element is arranged outside the panel sides, along a direction perpendicular to the normal axis of the touch surface, to receive light from the emitters, or to direct light to the detectors, around the panel sides.

30. A touch sensing apparatus according to claim 29, wherein the emitters and/or the detectors are arranged at least partly opposite the panel sides.

31. A touch sensing apparatus according to claim 20, wherein the panel comprises a rear surface, opposite the touch surface,
wherein the emitters and/or the detectors are arranged at least partly opposite the rear surface.

32. A touch sensing apparatus according to claim 31, wherein the light directing element is arranged to receive light from the emitters, or to direct light to the detectors, through the panel.

33. A touch sensing apparatus according to claim 20, wherein said light directing element is a first light directing element, and the touch sensing apparatus comprises a second light directing element arranged adjacent the parameter, wherein the second light directing element is arranged to receive light reflected by the first light directing element through a first surface and to couple out the received light through a second surface to direct the light across the touch surface substantially parallel to the touch surface.

34. A touch sensing apparatus according to claim 33, wherein the first light directing element receives light from the emitter along a width, wherein a projected height of the width along the normal axis is longer than a height of the first surface along the normal axis.

35. A touch sensing apparatus according to claim 33, wherein the second light directing element is positioned against the panel and extend with an off-set distance beyond a side of the panel towards the first light directing element in the direction of the plane.

36. A touch sensing apparatus according to claim 20, wherein the light directing element comprises a frame element of the touch sensing apparatus, wherein the frame element may be formed of black anodized metal to diffusively reflect the light towards the touch surface.

37. A touch sensing apparatus according to claim 21, wherein the diffusive light scattering element comprises at least one of an engineered diffusor, a substantially Lambertian diffusor, or a coating.

38. A touch sensing apparatus according to claim 21, wherein the diffusive light scattering element provides a reflector surface with a specular component of less than 5-10%.
